(19) United States
(12) Patent Application Publication
(10) Pub. No.: US 2023/0356243 A1
(43) Pub. Date: Nov. 9, 2023

(54) MARKER AIRBRUSH

(71) Applicant: Jianyue HAN, Cixi (CN)

(72) Inventor: Jianyue HAN, Cixi (CN)

(21) Appl. No.: 17/871,997

(22) Filed: Jul. 25, 2022

(30) Foreign Application Priority Data
May 7, 2022 (CN) 202221113706.5

(51) Int. Cl. B05B 7/24

(52) U.S. Cl. CPC B05B 7/2413; B05B 7/2429

(57) ABSTRACT

An airbrush matching with a marker is provided. The airbrush includes an airbrush body, a nozzle, an air pipe and an air source. The air source and the air pipe are disposed in the airbrush body. The air pipe is connected to and in communication with the air source, a first end of the nozzle is disposed in the airbrush body and connected to and in communication with the air pipe, and a second end of the nozzle extends out of the airbrush body. The airbrush further includes a support and an adjusting component, wherein the support is configured to fix the marker and is movably connected to the airbrush body. The adjusting component is movably connected to the airbrush body and connected to the support, and the adjusting component is capable of driving the support to move relative to the airbrush body.

### CROSS-REFERENCE TO RELATED APPLICATION

This application claims all benefits accruing from China Patent Application No. 202221113706.5, filed on May 7, 2022, in the China National Intellectual Property Administration, the content of which is hereby incorporated by reference.

### TECHNICAL FIELD

The present disclosure relates to tools of painting and writing, in particular, to a marker airbrush.

### BACKGROUND

Airbrush paintings are paintings drawn with an airbrush and a marker. In the processing of drawing, the marker cooperate with an air compression source disposed in the airbrush exports gas, which sprays pigments of a marker on paper or a drawing board.

In conventional art, a component of the airbrush, which is configured for fixing the markers, has a relatively simple structure. The airbrush cannot fix the markers with different diameters and lengths. Some of the airbrushes in conventional art have a fixing component, which can adapt to the markers with different diameters and lengths by adjusting sizes thereof. However, the markers can be hardly adjusted or hardly move after being fixed with the airbrush. When requirements of painting or air spraying changes, and positions and angles of nibs of the markers should be refined, the markers should be reinstalled to adjust the positions and angles of the nibs of the markers. However, the markers cannot be completely fixed even after the positions and angles of the nibs of the markers are adjusted, and the markers are not stable enough during a painting process.

### SUMMARY

In view of above, the present disclosure provides an airbrush.

The present disclosure provides an airbrush matching with a marker. The airbrush is configured to spray ink of the marker out, and includes an airbrush body, a nozzle, an air pipe and an air source. The air source and the air pipe are disposed in the airbrush body, and the air pipe is connected to and in communication with the air source. A first end of the nozzle is disposed in the airbrush body and connected to and in communication with the air pipe, and a second end of the nozzle extends out of the airbrush body. The airbrush further includes a support and an adjusting component. The support is configured to fix the marker and is movably connected to the airbrush body. The adjusting component is movably connected to the airbrush body and connected to the support, and the adjusting component is capable of driving the support to move relative to the airbrush body.

In the airbrush of the present disclosure, a position of the marker can be adjusted by the adjusting component. Upon conditions that the marker is unduly long, the adjusting component can drive the marker to move towards a direction away from the nozzle, so that a nib of the marker can be kept at a position right opposite to the nozzle. Upon conditions that the marker is unduly short, the adjusting component can drive the marker towards a direction near the nozzle, so that the nib of the marker can be kept at the position right opposite to the nozzle. The adjusting component can further adjust a distance between the nib of the marker and the nozzle, and adjust an angle defined by the nib of the marker and the nozzle, so as to accurately control thickness and atomization degree of sprayed ink.

In some embodiments, the adjusting component includes a first adjusting component. The first adjusting component is disposed at a first end away from the nozzle of the airbrush body and is connected to the support, and the first adjusting component is capable of moving to drive the support to move along a length direction of the airbrush body.

In some embodiments, the first adjusting component includes a first fixing member, a first moving member and a first abutting member. The first fixing member is disposed in the airbrush body and fixed to the airbrush body. The first moving member extends through the first fixing member and matches with the first fixing member. The first moving member is capable of moving relative to the first fixing member. A first end of the first moving member extends out from the airbrush body, and a second end of the first moving member is connected to the first abutting member. The first abutting member abuts against the support.

In some embodiments, the first moving member is a bolt, and the first fixing member is a nut.

In some embodiments, a side towards the airbrush body of the support is provided with a first locating member and a first matching member. The first locating member is annular-shaped. The first abutting member includes a first limiting portion and a first locating portion connecting with each other. The first locating portion extends through the first locating member and is connected to the first moving member. A first side of the first limiting portion abuts against the first fixing member, and a second end of the first limiting portion abuts against the first matching member.

In some embodiments, the first matching member is a protruding portion. A second end of the first matching member is connected to the support, and a first end of the first matching member extends towards the first limiting portion and abuts against the first limiting portion.

In some embodiments, the adjusting component includes a second adjusting component connected to the support, and the second adjusting component is capable of moving to drive an end near the nozzle of the support to move towards or away from the airbrush body.

In some embodiments, the second adjusting component includes a second fixing member, a second moving member and a second abutting member. The second fixing member is disposed in the airbrush body and fixed to the airbrush body. The second moving member extends through the second fixing member and matches with the second fixing member, and the second moving member is capable of moving relative to the second fixing member. A first end of the second moving member extends out from the airbrush body, and a second end of the second moving member is connected to the second abutting member. The second abutting member abuts against the support.

In some embodiments, the second moving member is a bolt, and the second fixing member is a nut.

In some embodiments, a side towards the airbrush body of the support is provided with a second locating member and a second matching member. The second locating member is annular-shaped. The second abutting member includes a second limiting portion and a second locating portion connected with each other. The second locating portion extends through the second locating member and is connected to the second moving member. A first side of the second limiting portion abuts against the second fixing member, and a second end of the second limiting portion abuts against a side of the airbrush body.

In some embodiments, the second adjusting component further includes a second matching member, and a side close to the airbrush body of the support is defined as a second matching member.

In some embodiments, support is further provided with a plurality of fasteners disposed at both sides of the support, and the plurality of fasteners are configured to clip the marker.

In some embodiments, the airbrush body includes a pedestal. The air source is disposed in the pedestal. The pedestal is further provided with a power source and a control panel. The air source is an air-blowing motor. The air source, the power source and the control panel are electrically connected.

### BRIEF DESCRIPTION OF THE DRAWINGS

FIG. 1 is a sectional view of an airbrush in an embodiment of the present disclosure.

FIG. 2 is an enlarged view of A portion in FIG. 1.

FIG. 3 is an enlarged view of B portion in FIG. 1.

FIG. 4 is a stereogram of an airbrush in an embodiment of the present disclosure.

In the figures, 100 represents an airbrush; 10 represents an airbrush body; 11 represents an adjusting component; 111 represents a first adjusting component; 112 represents a second adjusting component; 113a represents a first fixing member; 114a represents a first moving member; 115a represents a first abutting member; 1151a represents a first limiting portion; 1152a represents a first locating portion; 113b represents a second fixing member; 114b represents a second moving member; 115b represents a second abutting member; 1151b represents a second limiting portion; 1152b represents a second locating portion; 16 represents a nozzle; 20 represents a support; 21a represents a first locating member; 22a represents a first matching member; 21b represents a second locating member; 22b represents a second matching member; 23 represents a fastener; 30 represents a pedestal; 31 represents an air source; 32 represents an air pipe; 33 represents a control panel; 34 represents a power source; 35 represents a charging jack; and 36 represents a switch.

### DETAILED DESCRIPTION

In order to make the above objects, features and advantages of the present disclosure more clearly understood, the specific embodiments of the present disclosure will be described in detail below with reference to the accompanying drawings. In the following description, numerous specific details are set forth in order to provide a thorough understanding of the present disclosure. However, the present disclosure can be implemented in many other ways different from those described herein, and one of ordinary skill in the art can make similar improvements without departing from the connotation of the present disclosure. Accordingly, the present disclosure is not limited by the specific embodiments disclosed below.

It should be noted that when an element is referred to as being “fixed to” or “disposed on” another element, it may be directly attached to the other element or a further element may be presented between them. When an element is considered to be “connected” to another element, it may be directly connected to the other element or connected to the other element through a further element. The terms as used herein “vertical”, “horizontal”, “up”, “down”, “left”, “right”, and the like, are for illustrative purposes only and are not meant to be the only orientation.

In addition, the terms “first” and “second” are only used for descriptive purposes, and cannot be understood as indicating or implying relative importance or implying the number of indicated technical features. Thus, a feature delimited with “first”, “second” may expressly or implicitly include at least one of that feature. In the description of the present disclosure, “plurality” means at least two, such as two, three, etc., unless expressly and specifically defined otherwise.

In this disclosure, unless otherwise expressly stipulated and limited, the first feature “on”, “under” the second feature may be that the first feature is in direct contact with the second feature, or the first feature and the second feature Features are indirectly contacted through an intermediary. Furthermore, the first feature is “above”, “over” and “upwards” the second feature may mean that the first feature is directly above or obliquely above the second feature, or simply means that the first feature is level higher than the second feature. The first feature “below”, “beneath” and “downward” the second feature may mean that the first feature is directly below or diagonally below the second feature, or simply means that the first feature is level lower than the second feature.

Unless otherwise defined, all technical and scientific terms used in the specification of this disclosure have the same meaning as commonly understood by one of ordinary skill in the technical field belonging to this disclosure. The terms used in the specification of the present disclosure are for the purpose of describing specific embodiments only, and are not intended to limit the present disclosure. As used in this specification, the term “and/or” includes any and all combinations of one or more of the associated listed items.

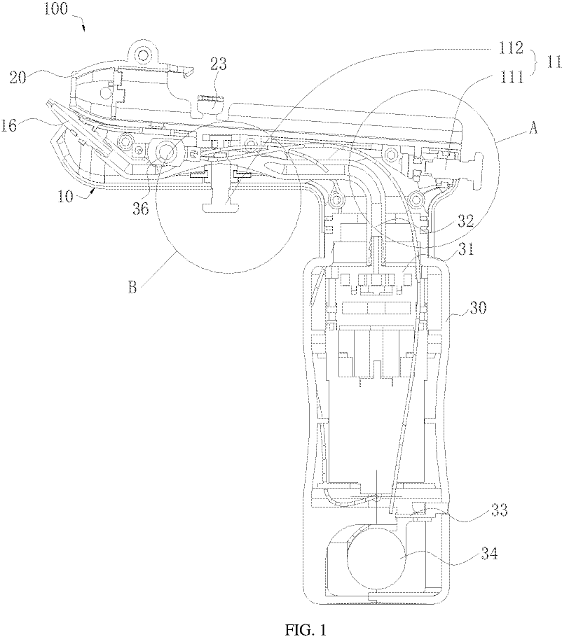

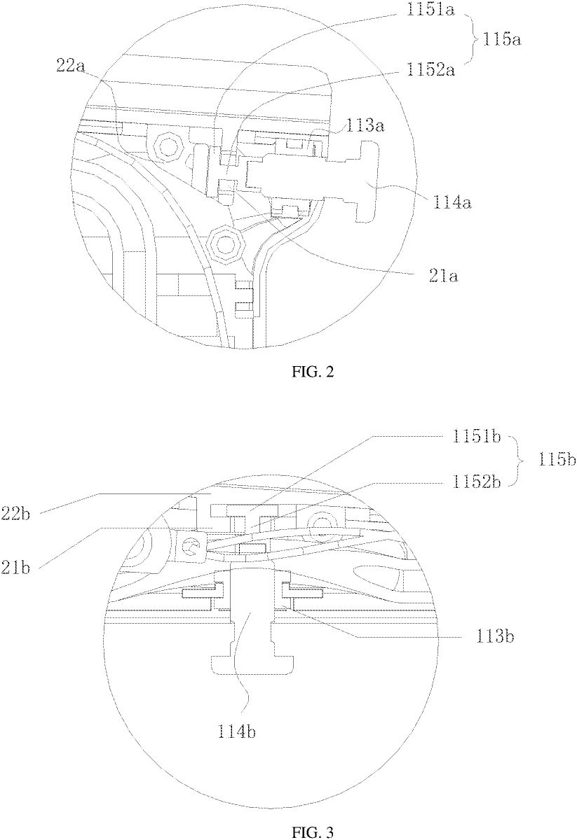

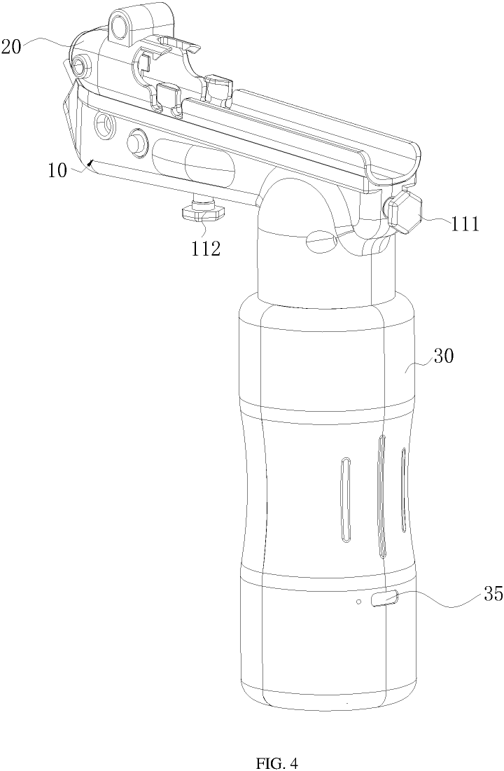

Referring to FIG. 1 to FIG. 3, the present disclosure provides an airbrush 100 used as tools of painting and writing, and is configured to spray pigment of markers on paper or a drawing board.

In conventional art, a component of the airbrush, which is configured for fixing the markers, has a relatively simple structure. The airbrush cannot fix the markers with different diameters and lengths. Some of the airbrushes in conventional art have a fixing component, which can adapt to the markers with different diameters and lengths by adjusting sizes thereof. However, the markers can be hardly adjusted or hardly move after being fixed with the airbrush. When requirements of painting or air spraying changes, and positions and angles of nibs of the markers should be refined, the markers should be reinstalled to adjust the positions and angles of the nibs of the markers. However, the markers cannot be completely fixed even after the positions and angles of the nibs of the markers are adjusted, and the markers are not stable enough during a painting process.

The present disclosure provides an airbrush 100 matching with a marker, configured to spray ink of the marker out. The airbrush can include an airbrush body 100, a nozzle 16, an air pipe 32 and an air source 31. The air source 31 and the air pipe 32 can be disposed in the airbrush body 10, the air pipe 32 can be connected to and in communication with the air source 31. A first end of the nozzle 16 can be disposed in the airbrush body and connected to and in communication with the air pipe 32, and a second end of the nozzle 16 can extend out of the airbrush body.

The airbrush 100 can further include a support 20 and an adjusting component 11, wherein the support 20 can be configured to fix the marker and connected to the air brush body 10. The adjusting component 11 can be movably connected to the airbrush body 10 and connected to the support 20, and the adjusting component 11 can be capable of driving the support 20 to move relative to the airbrush body 10.

In the airbrush 100 of the present disclosure, a position of the marker can be adjusted by the adjusting component 11. Upon conditions that the marker is unduly long, the adjusting component 11 can drive the marker to move towards a direction away from the nozzle 16, so that a nib of the marker can be kept at a position right opposite to the nozzle 16. Upon conditions that the marker is unduly short, the adjusting component 11 can drive the marker towards a direction near the nozzle 16, so that the nib of the marker can be kept at the position right opposite to the nozzle 16. The adjusting component 11 can further adjust a distance between the nib of the marker and the nozzle 16, and adjust an angle defined by the nib of the marker and the nozzle 16, so as to accurately control thickness and atomization degree of sprayed ink.

In some embodiments, the adjusting component 11 can include a first adjusting component 111. The first adjusting component 111 can be disposed at a first end away from the nozzle 16 of the airbrush body 10 and can be connected to the support 20, and the first adjusting component 111 can be capable of moving to drive the support 20 to move along a length direction of the airbrush body 10. Since the first adjusting component 111 can independently adjust the marker to move along the length direction of the airbrush body 10, an unduly long or unduly short marker can be adapt to the airbrush 100 of the present disclosure.

In some embodiments, the first adjusting component 111 can include a first fixing member 113a, a first moving member 114a and a first abutting member 115a. The first fixing member 113a can be disposed in the airbrush body 10 and fixed to the airbrush body 10. The first moving member 114a can extend through the first fixing member 113a and match with the first fixing member 113a. The first moving member 114a can be capable of moving relative to the first fixing member 113a. A first end of the first moving member 114a can extend out from the airbrush body 10, and a second end of the first moving member 114a can be connected to the first abutting member 115a. The first abutting member 115a abuts against the support 20. The first fixing member 113a can limit a motion path of the first moving member 114a, so as to ensure the motion path of the first moving member 114a not to shift, thereby making the adjusting component 11 to drive the marker to move stably.

In the present embodiment, the first adjusting member 111 can drive the marker to move by following steps: operating the first moving member 114a to move, so as to drive the first abutting member 115a to move simultaneously; and then driving the support 20 to move via a matching between the first abutting member 115a and the support 20, so as to adjust a position of the marker.

In some embodiments, the first moving member 114a can be a bolt, and the first fixing member 113a can be a nut. The bolt and the nut are easy to produce and process, have low costs, and can be stably matched. Therefore, the first moving member 114a can be continuously adjusted, so that the marker can by adjusted to any position, and more accurately controlled. In some embodiments, the first moving member 114a and the first fixing member 113a can be a guide rail and a moving member matching with the guide rail. The structures of the first moving member 114a and the first fixing member 113a can be not limited to the bolt and the nut in the present embodiment.

In some embodiments, a side towards the airbrush body 10 of the support 20 can be provided with a first locating member 21a and a first matching member 22a. The first locating member 21a can be annular-shaped. The first abutting member 115a can include a first limiting portion 1151a and a first locating portion 1152a connected with each other. The first locating portion 1152a can extend through the first locating member 21a and can be connected to the first moving member 114a. A first side of the first limiting portion 1151a can abut against the first locating member 21a, and a second end of the first limiting portion 1151a can abut against the first matching member 22a. The first locating member 21a can limit the first moving member 114a to prevent the first moving member 114a from detaching from the airbrush 100, so as to ensure the react of the first adjusting component 11. Both sides of the first limiting portion 1151a can match with the first locating member 21a, so that the first abutting member 115a can tightly match with the first locating member 21a. therefore, once the first moving portion 114a moves, the first matching member 22a can response simultaneously.

In some embodiments, when the first matching member 22a is matched with the first adjusting member 111, the first matching member 22a can be a protruding portion. An end of the protruding portion can be connected to the support 20, and the other end of the protruding portion can extend towards the first limiting portion 1151a and abut against the first limiting portion 1151a. The protruding portion is simple to be produced, and has low cost and stable structure. In some embodiments, the first matching member 22a can be designed as structures such as abutting plates and the like, and is not limited to be the protruding portion in the present embodiment.

In some embodiments, the adjusting component 11 can further include a second adjusting component 112 connected to the support 20, and the second adjusting component 112 can be capable of moving to drive an end near the nozzle 16 of the support 20 to move towards or away from the airbrush body 10. Therefore, the second adjusting component 112 can independently adjust a distance between the nib of the marker and the nozzle 16, so as to change thickness and atomization degree of ink sprayed from the airbrush 100, making the airbrush 100 satisfy more drawing requirements. Since the first adjusting component 111 can limit the first matching member 22a of the support 20, upon conditions that the second adjusting component 112 drives the support to move towards the direction away from the airbrush body 10, the support 20 can include to change position relationships between the nib of the marker and the nozzle 16.

In some embodiments, the second adjusting component 112 can further include a second fixing member 113b, a second moving member 114b and a second abutting member 115b. The second fixing member 113 can be disposed in the airbrush body 10 and fixed to the airbrush body 10. The second moving member 114b can extend through the second fixing member 113b and match with the second fixing member 113b, and the second moving member 114b can be capable of moving relative to the second fixing member 113b. A first end of the second moving member 114b can extend out from the airbrush body 10, and a second end of the second moving member 114b can be connected to the second abutting member. The second abutting member abuts against the support 20.

In some embodiments, the second moving member 114b can be a bolt, and the second fixing member 113b can be a nut.

In some embodiments, the second adjusting component 112 can further include a second matching member 22b, and a side close to the airbrush body 10 of the support 20 can be defined as a second matching member 22b. That is, the second abutting member 115b of the second adjusting component 112 can directly push a side wall towards the airbrush body 10 of the support 20 to drive the support 20 to move. It is not necessary to additionally dispose a matching structure between the support 20 and the second adjusting component 112, thus the structure is simple and the cost is lowered.

In some embodiments, the support 20 can be further provided with a plurality of fasteners 23 disposed at both sides of the support 20, and the plurality of fasteners 23 can be configured to clip the marker.

Sides close to the marker of the plurality of the fasteners 23 can have a concave cambered surface configured to match with an outer surface of the marker, so as to limit the marker along a circumferential direction of the marker. Therefore, the plurality of fasteners 23 can clip the markers with different shapes and sizes. Thus, the airbrush 100 can omit other assistance elements, and a processing for producing the airbrush 100 can be simplified.

In some embodiments, the airbrush body 10 can further include a pedestal 30 configured for the user to grip, and provide spaces for other elements of the airbrush 100 to make an entire structure of the airbrush 100 more regular.

In the present disclosure, the air source 31 can be an air-blowing motor disposed in the pedestal 30. The air-blowing motor is configured to convey air into the air pipe. Since the air-blowing motor has stable output power, the output airflow can have a stable flow rate, so that the ink of the marker can be continuously and evenly sprayed, thereby avoiding problems of ink cut-off. The air-blowing motor generally includes a motor with a fan, and the fan rotates to blow the air into the air pipe 32.

The airbrush 100 can be further provided with a power source 34, a control panel 33 and a switch 36. The switch 36 can be electrically connected to the power source 34 to open or close the power source 34. The power source 34 and the control panel 33 can be disposed in the pedestal 30. The power source 34 can be electrically connected to the air source 31 via the control panel 33. The airbrush 100 can be intelligently controlled by the control panel 33.

In some embodiments, the power source 34 can be an accumulator. The pedestal 30 can be provided with a charging jack 35. The charging jack 35 can be electrically connected to the accumulator, so that the airbrush can be re-used, thereby avoiding environmental pollution caused by continually changing batteries.

The technical features of the above-described embodiments may be combined in any combination. For the sake of brevity of description, not all possible combinations of the technical features in the above embodiments are described. However, as long as there is no contradiction between the combinations of these technical features, all should be considered as within the scope of this disclosure.

The above-described embodiments are merely illustrative of several embodiments of the present disclosure, and the description thereof is relatively specific and detailed, but is not to be construed as limiting the scope of the disclosure. It should be noted that a number of variations and modifications may be made by those skilled in the art without departing from the spirit and scope of the disclosure. Therefore, the scope of the disclosure should be determined by the appended claims.

We claim:

1. An airbrush matching with a marker, configured to spray ink of the marker out and comprising an airbrush body, a nozzle, an air pipe and an air source,
wherein the air source and the air pipe are disposed in the airbrush body, the air pipe is connected to and in communication with the air source, a first end of the nozzle is disposed in the airbrush body and connected to and in communication with the air pipe, and a second end of the nozzle extends out of the airbrush body,
the airbrush further comprises a support and an adjusting component, wherein the support is configured to fix the marker and is movably connected to the airbrush body, the adjusting component is movably connected to the airbrush body and connected to the support, and the adjusting component is capable of driving the support to move relative to the airbrush body.

2. The airbrush of claim 1, wherein the adjusting component comprises a first adjusting component, the first adjusting component is disposed at a first end away from the nozzle of the airbrush body and is connected to the support, and the first adjusting component is capable of moving to drive the support to move along a length direction of the airbrush body.

3. The airbrush of claim 1, wherein the first adjusting component comprises a first fixing member, a first moving member and a first abutting member,
wherein the first fixing member is disposed in the airbrush body and fixed to the airbrush body,
the first moving member extends through the first fixing member and matches with the first fixing member, the first moving member is capable of moving relative to the first fixing member, a first end of the first moving member extends out from the airbrush body, a second end of the first moving member is connected to the first abutting member, and the first abutting member abuts against the support.

4. The airbrush of claim 3, wherein the first moving member is a bolt, and the first fixing member is a nut.

5. The airbrush of claim 3, wherein a side towards the airbrush body of the support is provided with a first locating member and a first matching member,
wherein the first locating member is annular-shaped;
the first abutting member comprises a first limiting portion and a first locating portion connecting with each other, the first locating portion extends through the first locating member and is connected to the first moving member, a first side of the first limiting portion abuts against the first fixing member, and a second end of the first limiting portion abuts against the first matching member.

6. The airbrush of claim 5, wherein the first matching member is a protruding portion, a second end of the first matching member is connected to the support, and a first end of the first matching member extends towards the first limiting portion and abuts against the first limiting portion.

7. The airbrush of claim 1, wherein the adjusting component comprises a second adjusting component connected to the support, and the second adjusting component is capable of moving to drive an end near the nozzle of the support to move towards or away from the airbrush body.

8. The airbrush of claim 7, wherein the second adjusting component comprises a second fixing member, a second moving member and a second abutting member,
wherein the second fixing member is disposed in the airbrush body and fixed to the airbrush body,
the second moving member extends through the second fixing member and matches with the second fixing member, the second moving member is capable of moving relative to the second fixing member, a first end of the second moving member extends out from the airbrush body, a second end of the second moving member is connected to the second abutting member, and the second abutting member abuts against the support.

9. The airbrush of claim 8, wherein the second moving member is a bolt, and the second fixing member is a nut.

10. The airbrush of claim 8, wherein a side towards the airbrush body of the support is provided with a second locating member and a second matching member,
wherein the second locating member is annular-shaped;
the second abutting member comprises a second limiting portion and a second locating portion connected with each other, the second locating portion extends through the second locating member and is connected to the second moving member, a first side of the second limiting portion abuts against the second fixing member, and a second end of the second limiting portion abuts against a side of the airbrush body.

11. The airbrush of claim 10, wherein the second adjusting component further comprises a second matching member, and a side close to the airbrush body of the support is defined as a second matching member.

12. The airbrush of claim 1, wherein support is further provided with a plurality of fasteners disposed at both sides of the support, and the plurality of fasteners are configured to clip the marker.

13. The airbrush of claim 1, wherein the airbrush body comprises a pedestal, the air source is disposed in the pedestal,
wherein the pedestal is further provided with a power source and a control panel,
the air source is an air-blowing motor, and the air source, the power source and the control panel are electrically connected.
